(19) United States
(12) Patent Application Publication
(10) Pub. No.: US 2017/0025229 A1
(43) Pub. Date: Jan. 26, 2017

(54) COLLECTOR ELECTRODE PROTECTION LAYER FOR DYE-SENSITIZED SOLAR CELLS AND METHOD OF FORMING THE SAME

(71) Applicants: HYUNDAI MOTOR COMPANY, Seoul (KR); RESEARCH & BUSINESS FOUNDATION SUNGKYUNKWAN UNIVERSITY, Suwon-si (KR)

(72) Inventors: Won Jung KIM, Seoul (KR); Sang Hak KIM, Seoul (KR); Sol KIM, Suwon-si (KR); Jung Hee YANG, Suwon-si (KR); Mi Sook MIN, Suwon-si (KR); Hyo Young LEE, Suwon-si (KR)

(21) Appl. No.: 14/962,900

(22) Filed: Dec. 8, 2015

(30) Foreign Application Priority Data
Jul. 24, 2015 (KR) 10-2015-0105178

(51) Int. Cl. H01G 9/20; H01G 9/00

(52) U.S. Cl. CPC H01G 9/2022; H01G 9/0029

(57) ABSTRACT

A collector electrode protection layer for dye-sensitized solar cells includes an electrode layer formed on a transparent electrode substrate and having a plurality of metal electrodes which are spaced apart from each other; and a first barrier layer formed on an entire surface of the transparent electrode substrate on which the electrode layer is formed. The first barrier layer is a reduced graphene oxide.

### CROSS-REFERENCE TO RELATED APPLICATION

This application claims the benefit of priority under 35 U.S.C. §119(a) to Korean Patent Application No. 10-2015-0105178 filed on Jul. 24, 2015, the entire content of which is incorporated herein by reference.

### TECHNICAL FIELD

The present disclosure relates to a collector electrode protection layer for dye-sensitized solar cells, and a method of forming the same. More particularly, the present disclosure relates to a collector electrode protection layer for dye-sensitized solar cells capable of protecting a metal surface of a collector electrode from moisture, electrolytes, or air to prevent corrosion of the collector electrode, thus improving current collection efficiency, and a method of forming the same.

### BACKGROUND

As the size of solar cells increases, current collection efficiency is degraded due to the resistance in a transparent conductive layer. To compensate for this drawback, a metal electrode is generally inserted. However, the inserted metal electrode is often corroded by iodine-based electrolytes.

Accordingly, when glass frit, UV-curable or thermosetting polymer resin films and the like are applied to new electrode protection layers have been reported. Glass frit is a protective material having excellent characteristics as a glass material, but fails to completely protect collector electrodes within an allowable process temperature range of solar cells. As a result, the glass frit is not widely used. Particularly, since the glass frit is easily broken or cracked when pressure is applied to the glass frit or the glass frit is exposed to vibration or impact, the glass frit has a drawback in that it is difficult to prevent the corrosion caused by electrolytes.

In addition, epoxy resins are classified into thermosetting resins containing epoxy groups. The epoxy resins may be used in conjunction with a curing agent. Once such epoxy resins are cured and formed into shapes by applying heat to the epoxy resin, the epoxy resins have good heat resistance since they are not deformed even when heat is applied thereto. Generally, epoxy resins have also been widely used as adhesive materials since they have a good adhesive property. However, since endocrine disruptors produced upon the use of the epoxy resins may have a negative influence on human health as endocrine-disrupting chemicals, the epoxy resins are not good for use in a barrier layer, and iodine-based electrolytes may not be completely excluded.

Additionally, when a trace of a photoinitiator included in a UV-curable resin is exposed to UV rays to initiate photopolymerization so that the main components of a resin, for example, a monomer and an oligomer, are polymerized, the polymerized components are immediately cured by a UV curing agent. Thus, the UV curing agent has been used in various fields. However, photoelectrodes of the solar cells may be damaged by UV rays, a difference in curing rate according to a difference in thickness may be great, and it may be difficult to cure angled parts or uneven parts rather than flat surfaces of the electrodes. Like the thermosetting materials, the epoxy resins are known as materials from which it is difficult to completely exclude the iodine-based electrolytes.

As an example, a flexible metal dye-sensitized solar cell has been disclosed, in which a protective film and a transparent carbon-based thin film are carbon nanotube or graphene thin films.

The carbon-based film has excellent durability to organic solvents, heat, light, and gases, however, problems such as corrosion caused by the iodine-based electrolyte are not considered in the above related art.

Therefore, there is a need for novel materials as electrode protection layers capable of preventing corrosion of electrodes to enhance current collection efficiency.

The above information disclosed in this Background section is only for enhancement of understanding of the background of the invention, and therefore, it may contain information that does not form the prior art that is already known to a person of ordinary skill in the art.

### SUMMARY OF THE DISCLOSURE

The present disclosure has been made in an effort to solve the above-described problems associated with the prior art.

To solve the above problems, the collector electrode protection layer for dye-sensitized solar cells can be useful in protecting a metal surface of a collector electrode from moisture or air (oxygen) as well as an iodine-based electrolyte to prevent corrosion of the collector electrode by applying a superhydrophobic reduced graphene oxide to a first barrier layer as the collector electrode protection layer.

An aspect of the present inventive concept provides a collector electrode protection layer for dye-sensitized solar cells in which the superhydrophobic reduced graphene oxide is applied as a collector electrode protection layer.

Another aspect of the present inventive concept provides a method of forming a collector electrode protection layer for dye-sensitized solar cells, which is able to prevent corrosion of a collector electrode.

Still another aspect of the present inventive concept provides a dye-sensitized solar cell including a collector electrode protection layer.

Objects of the present inventive concepts are not limited to the aspects referred to above. Objects of the present inventive concept will be clarified through descriptions below and will be realized by means disclosed in the appended claims and combinations thereof.

In order to achieve the objects, the present disclosure includes embodiments as follows.

According to an embodiment in the present disclosure, a collector electrode protection layer for dye-sensitized solar cells, which includes an electrode layer formed on a transparent electrode substrate and having a plurality of metal electrodes arranged spaced apart from one another, and a first barrier layer formed on an entire surface of transparent electrode substrate on which the electrode layer is formed, or partially formed on the electrode layer only. The first barrier layer is a reduced graphene oxide.

According to another embodiment in the present disclosure, a method of forming a collector electrode protection layer for dye-sensitized solar cells, which includes forming an electrode layer by arranging a plurality of electrodes on a transparent electrode substrate so that the plurality of electrodes are spaced apart, and forming a first barrier layer on an entire surface of the transparent electrode substrate on which the electrode layer is formed, or partially on the electrode layer only. The step of forming the first barrier layer is performed by forming a reduced graphene oxide layer.

According to still another embodiment in the present disclosure, a dye-sensitized solar cell includes a collector electrode protection layer. The collector electrode protection layer comprises: an electrode layer formed on a transparent electrode substrate and having a plurality of metal electrodes arranged spaced apart; and a first barrier layer formed on an entire surface of the transparent electrode substrate on which the electrode layer is formed, or partially formed on the electrode layer only. The first barrier layer is a reduced graphene oxide

Other aspects and exemplary embodiments of the invention are discussed infra.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure, and wherein:

FIG. 1A is a process diagram showing a method of forming a collector electrode protection layer according to Example 1 of the present disclosure;

FIG. 1B is a cross-sectional view of the collector electrode protection layer according to Example 1 of the present disclosure;

FIG. 2A is a process diagram showing a method of forming a collector electrode protection layer according to Example 2 of the present disclosure;

FIG. 2B is a cross-sectional view of the collector electrode protection layer according to Example 2 of the present disclosure;

FIG. 3A is a process diagram showing a method of forming a collector electrode protection layer according to Example 3 of the present disclosure;

FIG. 3B is a cross-sectional view of the collector electrode protection layer according to Example 3 of the present disclosure;

FIG. 4A is a process diagram showing a method of forming a collector electrode protection layer according to Comparative Example 1 of the present disclosure;

FIG. 4B is a cross-sectional view of the collector electrode protection layer according to Comparative Example 1 of the present disclosure;

FIG. 5A is a graph illustrating the results of X-ray photoelectron spectroscopy (XPS) measurement of reduced graphene oxide (rGO) and GO according to Example 1 and Comparative Example 1 of the present disclosure;

FIG. 5B is a graph illustrating the results of XPS measurement of rGO according to Example 1 of the present disclosure;

FIG. 5C is a graph illustrating the results of XPS measurement of GO according to Comparative Example 1 of the present disclosure;

FIG. 6A is a scanning electron microscope (SEM) image of a collector electrode protection layer according to Example 1 of the present disclosure;

FIG. 6B is an image showing a dye-sensitized solar cell manufactured using the collector electrode protection layer according to Example 1 of the present disclosure;

FIG. 7 is an image showing results of evaluating corrosiveness of a dye-sensitized solar cell manufactured using the collector electrode protection layer according to Example 1 of the present disclosure;

FIG. 8 is an image showing the results of evaluating corrosiveness of a dye-sensitized solar cell manufactured using a collector electrode protection layer according to Comparative Example 1 of the present disclosure;

FIG. 9 is an image showing the results of evaluating corrosiveness of a dye-sensitized solar cell manufactured using a collector electrode protection layer according to Comparative Example 2 of the present disclosure.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawings.

### DETAILED DESCRIPTION

Hereinafter reference will now be made in detail to various embodiments, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents, and other embodiments, which may be within the spirit and scope of the invention as defined by the appended claims.

In the description of the present disclosure, certain detailed explanations of the related art are omitted when it is deemed that they may unnecessarily obscure the essence of the invention. Throughout this specification, unless explicitly described to the contrary, the expression “including” will be understood to imply the inclusion of stated elements but not the exclusion of any other elements.

A collector electrode protection layer for dye-sensitized solar cells according to the present disclosure includes: an electrode layer formed on a transparent electrode substrate and having a plurality of metal electrodes arranged spaced apart; and a first barrier layer formed on an entire surface of the transparent electrode substrate on which the electrode layer is formed or partially formed on the electrode layer. The first barrier layer may be a reduced graphene oxide (rGO).

According to one embodiment, the transparent electrode may be any one selected from the group consisting of a fluorine-doped tin oxide (FTO), an indium tin oxide (ITO), graphene, silver (Ag) nanowires, and a conductive polymer.

The graphene, which has come into the spotlight as a novel material, is currently researched in various fields due to inherent properties thereof. To prepare graphene, graphene is directly deposited onto a substrate such as copper foil, and mechanical and chemical exfoliation methods are applied. Thereamong, oxidized/reduced graphene prepared by the chemical exfoliation method using an oxidation-reduction reaction is a carbon nanomaterial including a single layer to several tens of layers, and thus shows excellent durability to organic solvents, heat, light, and gases (H₂S) as well as high transmissivity.

the metal electrode may include at least one selected from the group consisting of silver (Ag), copper (Cu), aluminum (Al), gold (Au), platinum (Pt), palladium (Pd), iron (Fe), zinc (Zn), titanium (Ti), chromium (Cr), nickel (Ni), and molybdenum (Mo).

The first barrier layer may be formed on an entire surface of the transparent electrode substrate on which the electrode layer is formed, or may be partially formed on the electrode layer only. Particularly, when the barrier layer is partially formed on the electrode layer, transparency of a dye-sensitized solar cell needs to be secured.

The reduced graphene oxide (rGO) may be used as the first barrier layer. Unlike the graphene oxide (GO), the rGO is conductive and has superhydrophobic properties. In addition, the rGO shows characteristics similar to the graphene manufactured by the direct deposition method, and may be mass-produced. In a case of such rGO, a GO may be reduced to form an rGO having superhydrophobic properties. The superhydrophobic properties of the rGO may protect the electrode layer by preventing a collector electrode from being corroded by an iodine-based electrolyte.

The first barrier layer may have a thickness of 0.01 to 100 μm. When the thickness of the first barrier layer is less than 0.01 μm, penetration of electrolytes may not be effectively prevented, which may cause corrosion of the collector electrode. When the thickness of the first barrier layer is greater than 100 μm, adhesive force to a substrate may be degraded, resulting in exfoliation from the substrate.

The collector electrode protection layer for dye-sensitized solar cells may further include a second barrier layer formed on an entire surface of the first barrier layer or the transparent electrode substrate on which the first barrier layer is partially formed.

The second barrier layer may be a polymer film made of polyvinyl alcohol (PVA) or a silane-based compound, or a silicon film. The second barrier layer may protect the collector electrode from corrosion by preventing the risk of electrolytes to penetrate through a bulky structure of rGO that is a material for forming the first barrier layer. In addition, the second barrier layer may be omitted according to desired conditions.

The second barrier layer may have a thickness of 0.1 to 200 μm. When the thickness of the second barrier layer is less than 0.1 μm, the barrier performance is insufficient. When the thickness of the second barrier layer is greater than 200 μm, the performance may decrease due to an increase in distance between upper and lower plates of the solar cell.

A method of forming a collector electrode protection layer for dye-sensitized solar cells according to another embodiment includes: forming an electrode layer by arranging a plurality of electrodes on a transparent electrode substrate so that the plurality of electrodes are spaced apart by predetermined intervals; and forming a first barrier layer on an entire surface of the transparent electrode substrate on which the electrode layer is formed or forming partially on the electrode layer only. The step of forming the first barrier layer is performed by forming an rGO layer.

The first barrier layer may be formed by any one technique selected from spray coating, roll coating, slot-die coating, bar coating, spin coating, ink-jet coating, and dip coating techniques, but the present disclosure is not limited thereto. The first barrier layer may be formed by a spray coating technique. In this case, when the first barrier layer is partially formed on the electrode layer only, the first barrier layer may be coated using a mask sheet so that the first barrier layer is not formed on an unnecessary portion of the electrode layer.

The step of forming the first barrier layer may be performed by coating a rGO solution. That is, the first barrier layer may be formed by partially coating the rGO solution on the entirety of the transparent electrode substrate on which the electrode layer is formed, or coating the rGO solution on the electrode layer only.

The first barrier layer may be formed by coating with a GO solution and reducing the coated GO to form an rGO. Here, the GO solution may be prepared from graphene using a direct synthesis method, a mechanical exfoliation method, a chemical exfoliation method, etc. The GO solution may be prepared by the chemical exfoliation method by subjecting graphite, in which several layers of graphene are stacked, to a chemical treatment such as acid treatment, etc. When the graphite undergoes an acid treatment, a portion of a graphene surface has ⁻OH or ⁻COOH groups. Such graphene may be dispersed in water or an organic solvent to prepare a GO. In addition, the GO solution may be coated onto the entire surface of the transparent electrode substrate on which the electrode layer is formed, or partially coated onto the electrode layer only.

The reducing may be performed at a temperature of 200 to 500° C. for 1 to 10 hours under a 4% H₂/Ar gas atmosphere. That is, the surface of graphene coated with the GO solution may be heat-treated at a high temperature of 200 to 500° C. in a high vacuum furnace so that graphene is reduced into an rGO, thereby forming the first barrier layer. When the reducing temperature is less than 200° C., some of the ⁻COOH and ⁻OH groups may remain, and thus, the characteristics of rGO may not be acquired. When the reducing temperature is greater than 500° C., the performance of the solar cell may be degraded since heat is applied to the solar cell at a temperature above the process temperature.

A solid content in the GO solution or the rGO solution may be in a range of 0.01 to 50 mg/mL. When the solid content is less than 0.01 mg/mL, it may be difficult to completely cover the collector electrode. When the solid content is greater than 50 mg/mL, solution dispersibility may deteriorate, and uniform coating may be difficult.

The first barrier layer may have a thickness of 0.01 to 100 μm.

The method may further include forming a second barrier layer on the entire surface of the first barrier layer or the transparent electrode substrate on which the first barrier layer is partially formed.

The second barrier layer may be a polymer film made of PVA or a silane-based compound, or a silicon film. In a case of polyvinyl alcohol, the first barrier layer may be coated with an aqueous polyvinyl alcohol solution, in which polyvinyl alcohol is present in an amount of 0.1 to 10% by weight in at least one solvent selected from the group consisting of water, ethanol, methanol, acetone, isopropyl alcohol, and butanol, to form the second barrier layer.

The second barrier layer may have a thickness of 0.1 to 200 μm.

According to another embodiment, a dye-sensitized solar cell includes the collector electrode protection layer.

Therefore, a metal surface of the collector electrode can be protected from iodine-based electrolytes, moisture, or air (oxygen) to prevent corrosion of the collector electrode, thus improving current collection efficiency by applying a superhydrophobic rGO as the collector electrode protection layer. In addition, corrosion of the collector electrode can be prevented by coating a polymer film or a silicon film on the rGO to form a collector electrode protection layer having a bilayer structure.

Hereinafter, one or more embodiments in the present disclosure will be described in detail with reference to the following examples. However, these examples are not intended to limit the purpose and scope of the one or more embodiments.

### EXAMPLES

The following examples illustrate the invention and are not intended to limit the same.

### Example 1

An Ag paste was coated onto a glass coated with a fluorine-doped tin oxide (FTO) as a material for transparent electrodes constituting a dye-sensitized solar cell, and then heat-treated at 500° C. for 30 minutes to form an Ag electrode. Thereafter, 5 mg/mL of a GO solution was coated using a spray coating method, and the coated GO was reduced at 300° C. for 5 hours by bubbling a 4% H₂/Ar gas mixture to form a first barrier layer of rGO. The thickness of the formed first barrier layer was 0.5 μm. Then, an aqueous solution in which 5% by weight of polyvinyl alcohol (PVA) was dissolved in ethanol was coated onto the first barrier layer by a spraying method to form a second barrier layer. In this case, the thickness of the second barrier layer was 10 μm.

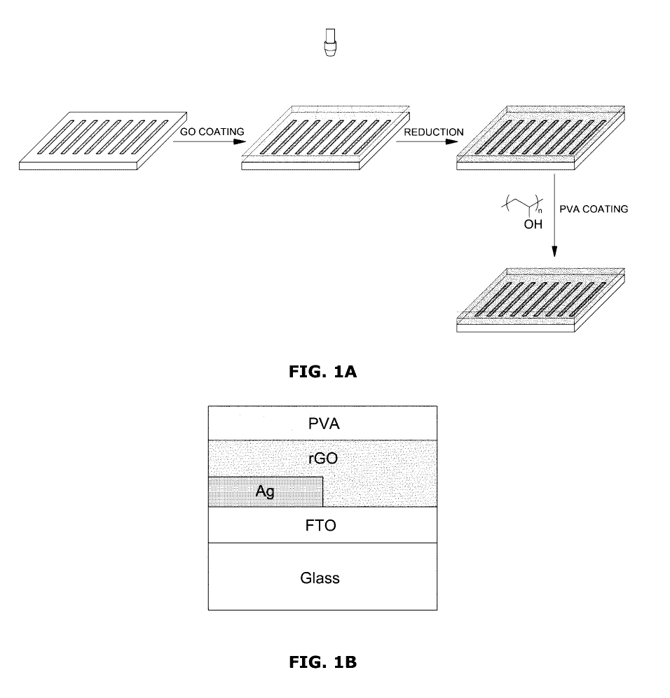

FIG. 1A is a process diagram showing a method of forming a collector electrode protection layer according to Example 1. As shown in FIG. 1A, Ag electrodes were arranged on a glass coated with FTO to be spaced apart to form an electrode layer, and GO was primarily coated onto the electrode layer, and then reduced to form a first barrier layer coated with an rGO. Next, a collector electrode protection layer in which the first barrier layer was secondarily coated with PVA to form a second barrier layer is shown in FIG. 1A. FIG. 1B is a cross-sectional view of the collector electrode protection layer according to Example 1.

### Example 2

An Ag paste was coated onto a glass coated with FTO as a material for transparent electrodes constituting a dye-sensitized solar cell, and then heat-treated at 500° C. for 30 minutes to form an Ag electrode. Thereafter, a mask sheet was attached to the glass to coat the Ag electrode only, and 5 mg/mL of a graphene oxide (GO) solution was coated onto the mask sheet using a spray coating method. The coated GO was reduced at 300° C. for 5 hours by bubbling a 4% H₂/Ar gas mixture to form a first barrier layer in which a reduced graphene oxide (rGO) was coated onto the Ag electrode only. The thickness of the formed first barrier layer was 0.5 μm. Then, an aqueous solution in which 5% by weight of PVA was dissolved in ethanol was coated onto the entire surface of the first barrier layer and an FTO layer by a spraying method to form a second barrier layer. In this case, the thickness of the second barrier layer was 10 μm.

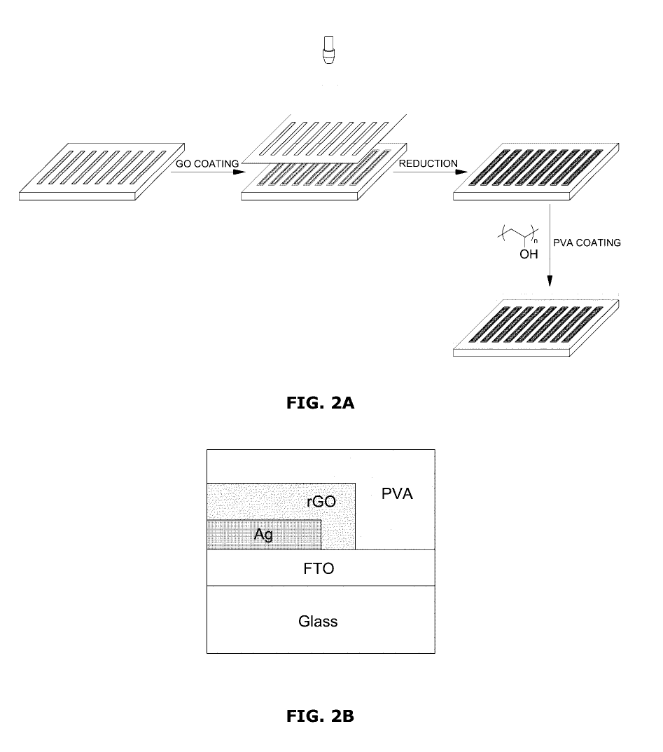

FIG. 2A is a process diagram showing a method of forming a collector electrode protection layer according to Example 2. As shown in FIG. 2A, Ag electrodes were arranged on a glass coated with FTO to be spaced apart to form an electrode layer, and GO was primarily coated onto the electrode layer only using a mask sheet, and then reduced to form a first barrier layer coated with an rGO. Next, a collector electrode protection layer in which the first barrier layer was secondarily coated with PVA to form a second barrier layer is shown in FIG. 2A. FIG. 2B is a cross-sectional view of such a collector electrode protection layer according to Example 2.

### Example 3

An Ag paste was coated onto a glass coated with FTO as a material for transparent electrodes constituting a dye-sensitized solar cell, and then heat-treated at 500° C. for 30 minutes to form an Ag electrode. Thereafter, 5 mg/mL of an rGO solution was coated using a spray coating method, and then dried at 300° C. for 1 hour to form a first barrier layer. The thickness of the formed first barrier layer was 0.5 μm. Then, an aqueous solution in which 5% by weight of PVA was dissolved in ethanol was coated onto the first barrier layer by a spraying method to form a second barrier layer. In this case, the thickness of the second barrier layer was 20 μm.

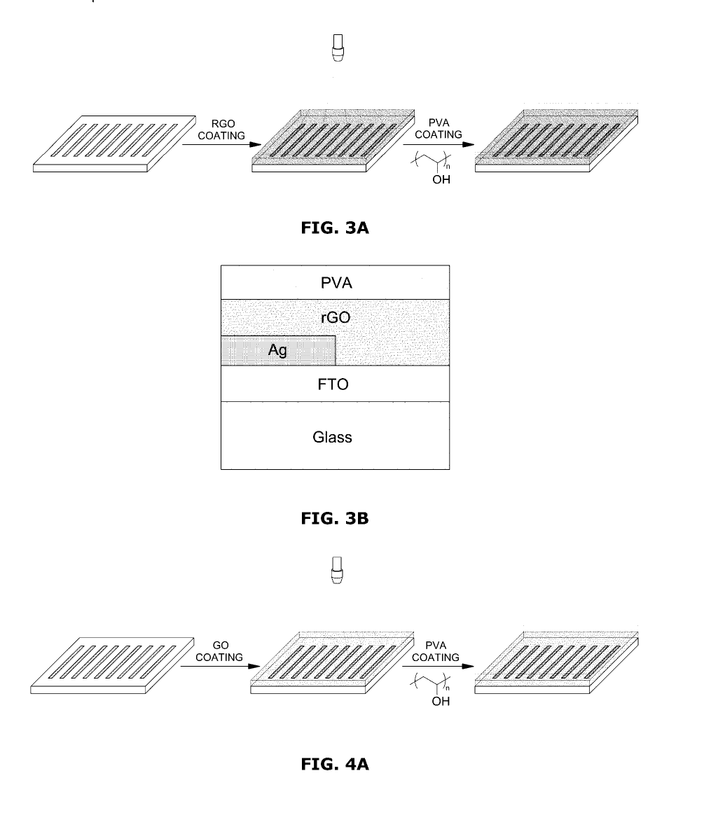

FIG. 3A is a process diagram showing a method of forming a collector electrode protection layer according to Example 3. As shown in FIG. 3A, Ag electrodes were arranged on a glass coated with FTO to be spaced apart to form an electrode layer, and an rGO was primarily coated onto the electrode layer to form a first barrier layer. Next, a collector electrode protection layer in which the first barrier layer was secondarily coated with PVA to form a second barrier layer is shown in FIG. 3A. FIG. 3B is a cross-sectional view of such a collector electrode protection layer according to Example 3.

### Example 4

GO was dispersed in 5 mg/mL of water, 1 mL of hydrazine hydrate was added thereto, and the resulting mixture was reacted at 80° C. for 3 hours. Thereafter, a solvent was removed, and the mixture was washed with ethanol, and dried for 15 hours to obtain an rGO. The resulting rGO was dispersed in dimethylformamide (DMF). Here, 5 mL of an ammonia solution was added to improve solubility of the solution, and the resulting mixture was reacted for 2 hours to remove the ammonia solution. Then, 5 mg/mL of the prepared rGO was directly coated onto a glass coated with FTO as a material for transparent electrodes constituting a dye-sensitized solar cell, to form a first barrier layer. The thickness of the formed first barrier layer was 0.5 μm. Subsequently, an aqueous solution in which 5% by weight of PVA was dissolved in ethanol was coated onto the first barrier layer by a spraying method to form a second barrier layer. In this case, the thickness of the second barrier layer was 20 μm.

### Comparative Example 1

An Ag paste was coated onto a glass coated with FTO as a material for transparent electrodes constituting a dye-sensitized solar cell, and then heat-treated at 500° C. for 30 minutes to form an Ag electrode. Thereafter, 5 mg/mL of a GO solution was coated using a spray coating method, and then dried at 300° C. for 1 hour to form a first barrier layer. The thickness of the formed first barrier layer was 0.5 μm. Then, an aqueous solution in which 5% by weight of PVA was dissolved in ethanol was coated onto the first barrier layer by a spraying method to form a second barrier layer. In this case, the thickness of the second barrier layer was 20 μm.

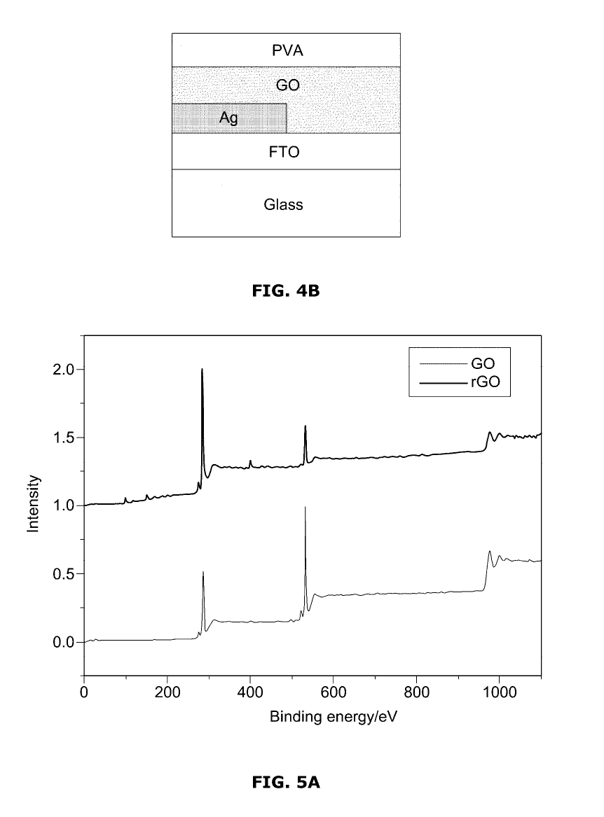

FIG. 4A is a process diagram showing a method of forming a collector electrode protection layer according to Comparative Example 1. As shown in FIG. 4A, Ag electrodes were arranged on a glass coated with FTO to be spaced apart to form an electrode layer, and GO was primarily coated onto the electrode layer to form a first barrier layer. Next, a collector electrode protection layer in which the first barrier layer was secondarily coated with PVA to form a second barrier layer is shown in FIG. 4A. FIG. 4B is a cross-sectional view of such a collector electrode protection layer according to Comparative Example 1.

### Comparative Example 2

An Ag paste was coated onto a glass coated with FTO as a material for transparent electrodes constituting a dye-sensitized solar cell, and then heat-treated at 500° C. for 30 minutes to form an Ag electrode. Thereafter, an epoxy-based UV curing agent was coated by a screen printing method, dried at 80° C. for 30 minutes, and then cured through UV radiation to form a barrier layer. The thickness of the formed barrier layer was 30 μm.

### TEST EXAMPLES

### Test Example 1

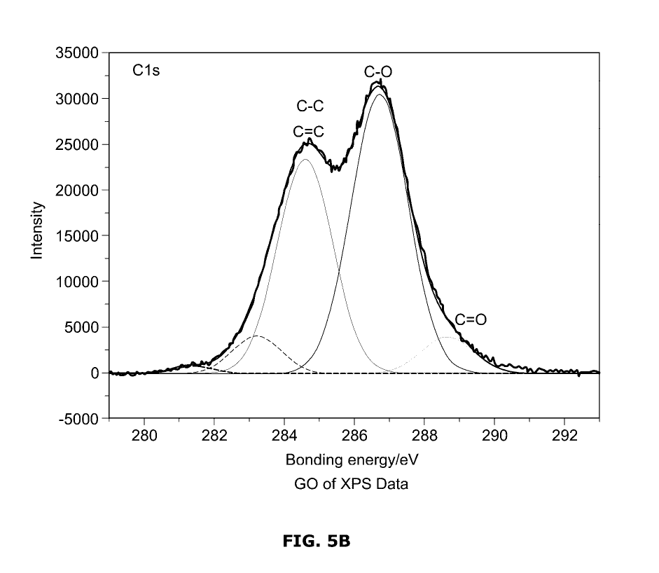

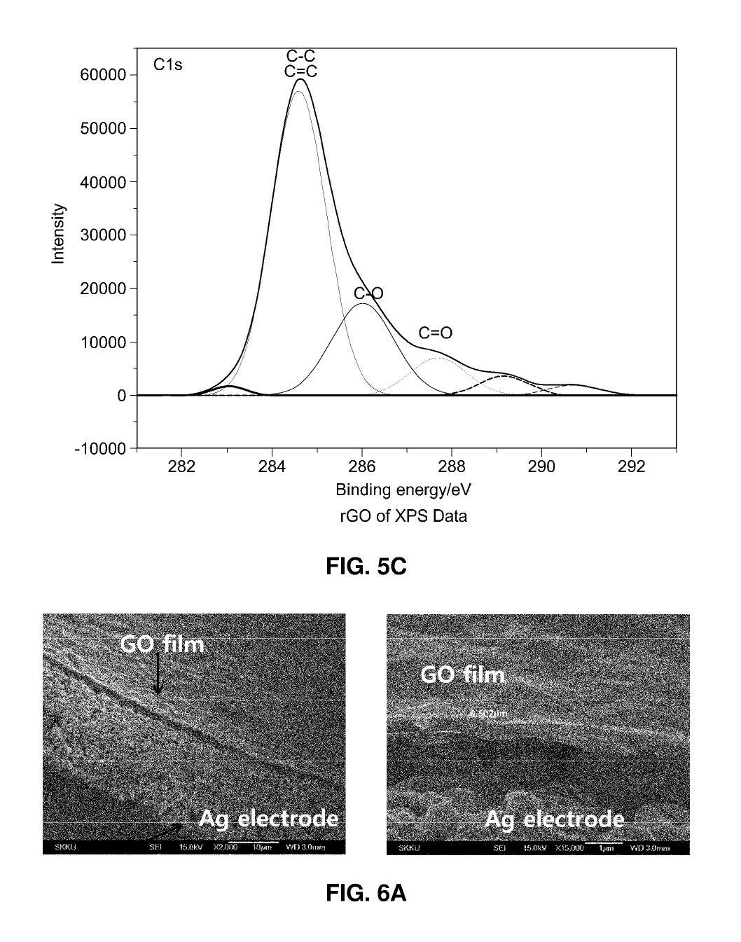

X-ray photoelectron spectroscopy (XPS) measurements were performed to determine a coating material for the first barrier layer as the collector electrode protection layer prepared in Example 1 and Comparative Example 1. The results are shown in FIGS. 5A, 5B, and 5C.

FIG. 5A is a graph illustrating the results of XPS measurement of rGO and GO according to Example 1 and Comparative Example 1. FIG. 5B is a graph illustrating the results of XPS measurement of rGO according to Example 1, and FIG. 5C is a graph illustrating the results of XPS measurement of GO according to Comparative Example 1.

Referring to FIGS. 5A to 5C, it was revealed from the peaks measured by XPS that the GO-coated and rGO-coated layers were properly formed as the first barrier layers prepared in Example 1 and Comparative Example 2, respectively.

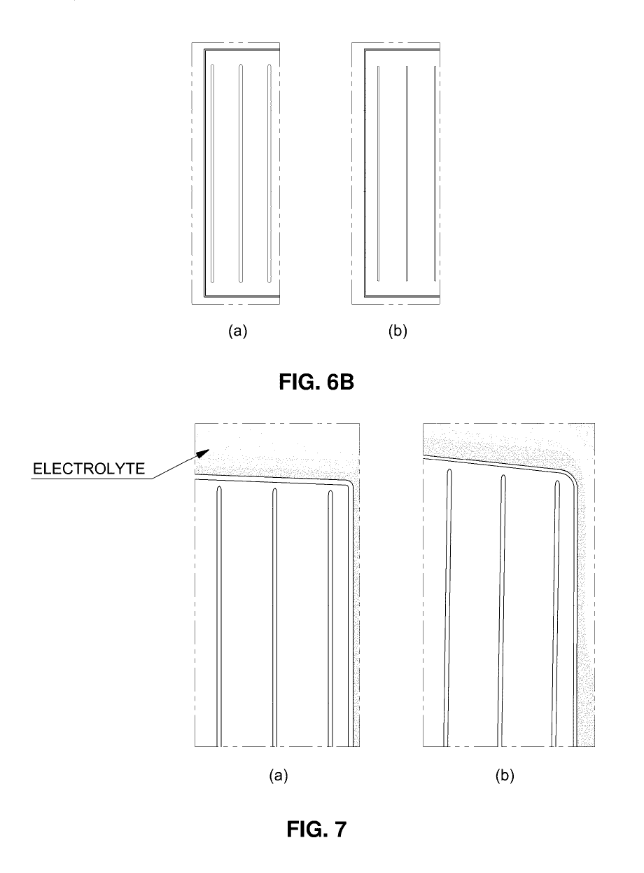

FIG. 6A is a scanning electron microscope (SEM) image of the collector electrode protection layer according to Example 1. As shown in FIG. 6A, it was revealed that the GO-coated layer was properly formed on the Ag electrode, and the thickness of the GO-coated layer was 0.5 μm.

FIG. 6B is an image showing a dye-sensitized solar cell manufactured using the collector electrode protection layer according to Example 1. In FIG. 6B, (A) is an image of a front surface of a dye-sensitized solar cell in which GO was formed on an Ag collector electrode, and (B) is an image of a rear surface of the dye-sensitized solar cell. There was no change in colors of the Ag collector electrode, it was revealed that the Ag collector electrode was not damaged when GO was formed.

### Test Example 2

The dye-sensitized solar cells manufactured using the collector electrode protection layers prepared in Example 1 and Comparative Examples 1 and 2 were impregnated with an iodine-based electrolyte for 500 hours, and surfaces of the dye-sensitized solar cells were observed with the naked eye. Results are shown in FIGS. 7, 8, and 9.

FIG. 7 is an image showing the results of evaluating corrosiveness of a dye-sensitized solar cell manufactured using the collector electrode protection layer according to Example 1. Specifically, (A) is an image of the dye-sensitized solar cell before impregnation with the electrolyte, and (B) is an image of the dye-sensitized solar cell after impregnation with the electrolyte. It was revealed that regions (white) in which the collector electrode protection layer was formed were observed after 500 hours, and maintained in a stable state in (B) of FIG. 7, compared to that in (A) of FIG. 7, indicating that there was no sign of corrosion.

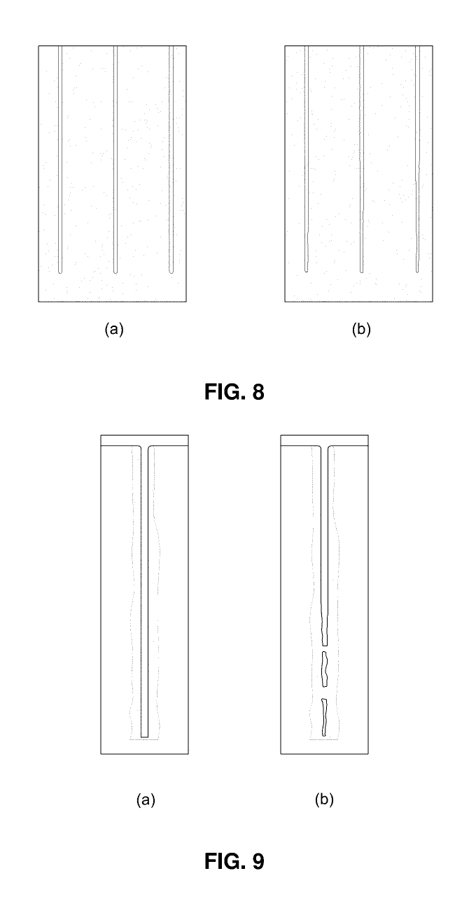

FIG. 8 is an image showing results of evaluating corrosiveness of a dye-sensitized solar cell manufactured using the collector electrode protection layer according to Comparative Example 1. Specifically, (A) is an image of the dye-sensitized solar cell before impregnation with the electrolyte, and (B) is an image of the dye-sensitized solar cell after impregnation with the electrolyte. It was revealed that regions (white) in which the collector electrode protection layer was formed was corroded within approximately 150 hours of impregnation with the electrolyte in (B) of FIG. 8, compared to that in (A) of FIG. 8.

FIG. 9 is an image showing results of evaluating corrosiveness of a dye-sensitized solar cell manufactured using a collector electrode protection layer according to Comparative Example 2. Specifically, in FIG. 9, (A) shows an Ag collector electrode and a barrier layer formed before impregnation with the electrolyte, and (B) is an image showing that the electrolyte penetrated into the barrier layer within approximately 24 hours of impregnation with the electrolyte, and the collector electrode collapsed due to the corrosion of the collector electrode.

Therefore, it was confirmed that a metal surface of the collector electrode can be protected from iodine-based electrolytes, moisture, or air (oxygen) to prevent corrosion of the collector electrode, and thus improve current collection efficiency, by applying the superhydrophobic rGO as the collector electrode protection layer according to the embodiment in the present disclosure.

Therefore, a metal surface of the collector electrode can be protected from iodine-based electrolytes, moisture, or air (oxygen) to prevent corrosion of the collector electrode, thus improving current collection efficiency by applying the superhydrophobic rGO to the first barrier layer as the collector electrode protection layer according to the preferred embodiment of the present disclosure.

Further, corrosion of the collector electrode can be prevented by coating a polymer film or a silicon film onto the rGO to form a collector electrode protection layer having a bilayer structure.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

1. A collector electrode protection layer for dye-sensitized solar cells comprising:
an electrode layer formed on a transparent electrode substrate and having a plurality of metal electrodes which are spaced apart from each other; and
a first barrier layer formed on an entire surface of the transparent electrode substrate on which the electrode layer is formed,
wherein the first barrier layer is a reduced graphene oxide.

2. The collector electrode protection layer of claim 1, wherein the transparent electrode is any one selected from the group consisting of a fluorine-doped tin oxide (FTO), an indium tin oxide (ITO), graphene, silver (Ag) nanowires, and a conductive polymer.

3. The collector electrode protection layer of claim 1, wherein the metal electrode comprises at least one selected from the group consisting of silver (Ag), copper (Cu), aluminum (Al), gold (Au), platinum (Pt), palladium (Pd), iron (Fe), zinc (Zn), titanium (Ti), chromium (Cr), nickel (Ni), and molybdenum (Mo).

4. The collector electrode protection layer of claim 1, wherein the first barrier layer has a thickness of 0.01 to 100 μm.

5. The collector electrode protection layer of claim 1, further comprising: a second barrier layer formed on an entire surface of the first barrier layer.

6. The collector electrode protection layer of claim 5, wherein the second barrier layer is a polymer film, which is formed of polyvinyl alcohol (PVA) or a silane-based compound, or a silicon film.

7. The collector electrode protection layer of claim 5, wherein the second barrier layer has a thickness of 0.1 to 200 μm.

8. The collector electrode protection layer of claim 1, wherein the first barrier layer is partially formed on the electrode layer.

9. The collector electrode protection layer of claim 8, further comprising: a second barrier layer formed on the entire surface of the transparent electrode substrate on which the first barrier layer is partially formed.

10. A method of forming a collector electrode protection layer for dye-sensitized solar cells, the method comprising:
forming an electrode layer by arranging a plurality of electrodes on a transparent electrode substrate so that the plurality of electrodes are spaced apart; and
forming a first barrier layer on an entire surface of the transparent electrode substrate on which the electrode layer is formed,
wherein the step of forming the first barrier layer is performed by forming a reduced graphene oxide layer.

11. The method of claim 10, wherein the step of forming the first barrier layer is performed by coating with a reduced graphene oxide solution.

12. The method of claim 10, wherein the step of forming the first barrier layer is performed by coating with a graphene oxide solution and reducing the coated graphene oxide to form reduced graphene oxide.

13. The method of claim 12, wherein the coated graphene oxide reduced at a temperature of 200 to 500° C. for 1 to 10 hours.

14. The method of claim 12, wherein a content of solids in the graphene oxide solution or the reduced graphene oxide solution is in a range of 0.01 to 50 mg/mL.

15. The method of claim 10, wherein the first barrier layer has a thickness of 0.01 to 100 μm.

16. The method of claim 10, further comprising: forming a second barrier layer on an entire surface of the first barrier layer or the transparent electrode substrate on which the first barrier layer is partially formed.

17. The method of claim 16, wherein the second barrier layer is a polymer film which is made of PVA or a silane-based compound, or a silicon film.

18. The method of claim 16, wherein the second barrier layer has a thickness of 0.1 to 200 μm.

19. The method of claim 10, wherein the first barrier layer is formed partially on the electrode layer.

20. A dye-sensitized solar cell comprising a collector electrode protection layer, wherein the collector electrode protection layer comprises:
an electrode layer formed on a transparent electrode substrate and having a plurality of metal electrodes arranged spaced apart; and
a first barrier layer formed on an entire surface of the transparent electrode substrate on which the electrode layer is formed, or partially formed on the electrode layer, wherein the first barrier layer is reduced graphene oxide.
